(19) United States
(12) Patent Application Publication
(10) Pub. No.: US 2007/0244902 A1
(43) Pub. Date: Oct. 18, 2007

(54) Internet search-based television

(75) Inventors: Frank T.B. Seide, Beijing (CN); Lie Lu, Beijing (CN); Neema M. Moraveji, Beijing (CN); Roger Peng Yu, Beijing (CN); Wei-Ying Ma, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/405,369

(22) Filed: Apr. 17, 2006

(51) Int. Cl. G06F 17/30

(52) U.S. Cl. 707/10

(57) ABSTRACT

The best features of both Internet video search and television-type viewing experience have been combined. A user may use a remote control to enter search terms on a television monitor. A search engine may then search for video files accessible on the Internet that correspond to the search terms. Indicators of relevant search results may then be shown on the television monitor, enabling the user to select one to play. This enables the user to search for and view Internet video content in a television-like experience.

### BACKGROUND

The Internet is a popular tool for distributing video. A variety of search engines are available that allow users to search for video on the Internet. Video search engines are typically used by navigating a graphical user interface with a mouse and typing search terms with a keyboard into a search field on a web page. Internet-delivered video found by the search is typically viewed in a relatively small format on a computer monitor on a desk at which the user is seated. The typical Internet video viewing experience is therefore significantly different from the typical television viewing experience, in which programs delivered by broadcast television channels, cable television channels, or on-demand cable are viewed on a relatively large television screen from across a portion of a room.

The discussion above is merely provided for general background information and is not intended to be used as an aid in determining the scope of the claimed subject matter.

### SUMMARY

A variety of new embodiments have been invented for search-based video with a remote control user interface, that combine the best features of both Internet video search and a television viewing experience. As embodied in one illustrative example, a user may use a remote control to enter search terms on a television screen. The search terms may be entered using a standard numeric keypad on a remote control, using predictive text methods similar to those commonly used for text messaging. A search engine may then search transcripts of video files accessible on the Internet for video files with transcripts that correspond to the search terms. The transcripts may be included in metadata provided with the video files, or as text generated from the video files by automatic speech recognition. Indicators of relevant search results may then be shown on the television screen, with thumbnail images and snippets of transcripts containing the search terms for each of the video files listed among the search results. A user may then use the remote control to select one of the search results and watch the selected video file.

The Summary and Abstract are provided to introduce a selection of concepts in a simplified form that are further described below in the Detailed Description. The Summary and Abstract are not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts a search-based video system with a remote user interface, in a typical usage setting, according to an illustrative embodiment.

FIG. 2 depicts a flowchart of a method for search-based video with a remote user interface, according to an illustrative embodiment.

FIG. 3 depicts a screenshot of a search field superimposed on a television program, according to an illustrative embodiment.

FIG. 4 depicts a screenshot of text samples and thumbnail images indicating video search results, according to an illustrative embodiment.

FIG. 5 depicts a screenshot of a video file from a video search, according to an illustrative embodiment.

FIG. 6 depicts a screenshot of text samples and thumbnail images indicating video search results, and an option for saving a search, according to an illustrative embodiment.

FIG. 7 depicts a screenshot of a saved channel menu page, according to an illustrative embodiment.

FIG. 8 depicts a screenshot of a menu of automatically generated selectable keywords, according to an illustrative embodiment.

FIG. 9 depicts a block diagram of a computing environment, according to an illustrative embodiment.

### DETAILED DESCRIPTION

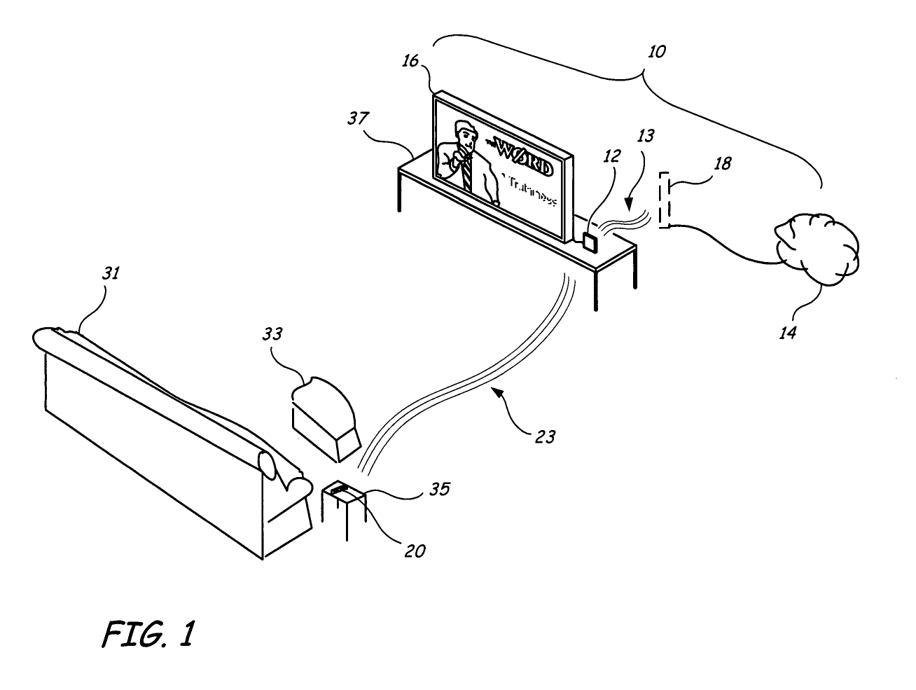

FIG. 1 depicts a block diagram of a search-based video system 10 with a remote user input device, such as remote control 20, according to an illustrative embodiment. This depiction and the description accompanying it provide one illustrative example from among a broad variety of different embodiments intended for a search-based, television-like video system. Accordingly, none of the particular details in the following description are intended to imply any limitations on other embodiments. In this illustrative embodiment, search-based video system 10 provides network search-based video in a television-like experience, and which may be implemented in part by computing device 12, connected to television monitor 16 and to network 14, such as the Internet, through wireless signal 13 connecting it to wireless hub 18, in this illustrative example. Television monitor 16 and computing device 12 rest on coffee table 37, in the example of FIG. 1. Couch 31, ottoman 33, and end table 35 are situated across the room from television monitor 16 and computing device 12, providing a comfortable and convenient setting, typical of television viewing settings, for one or several viewers to view television monitor 16. Remote control 20 rests on end table 35 where it is easily accessible by a viewer seated on couch 31. Computing device 12 may have a remote control signal receiver, and remote control 20 may be enabled to communicate signals 23, such as infrared signals, from the viewer or user to the computing device 12.

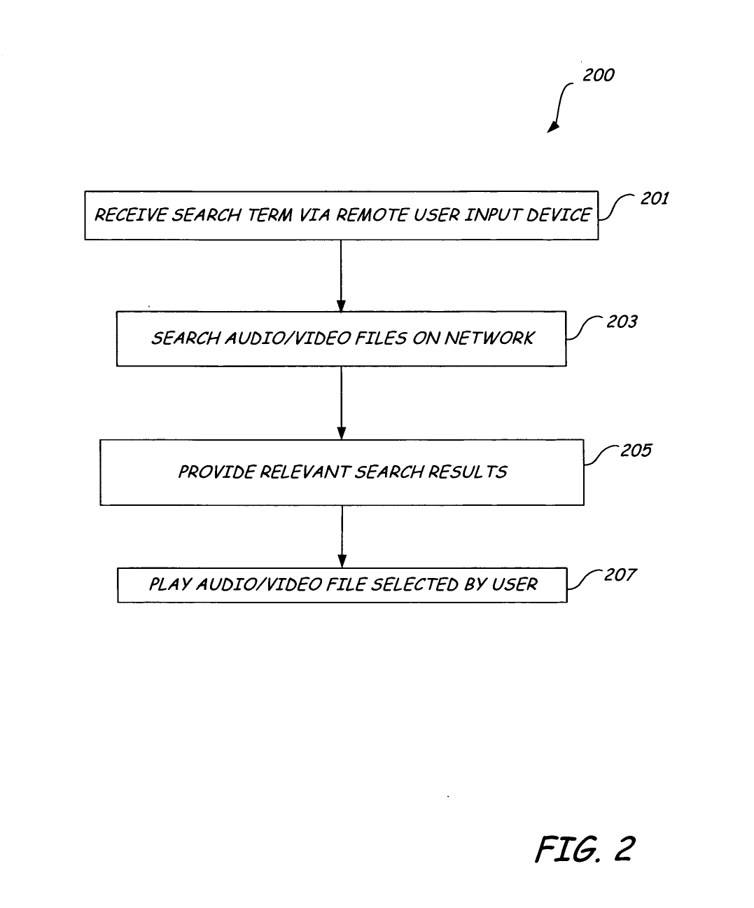

FIG. 2 depicts a flowchart of a method 200 for search-based video with a remote user input device, according to an illustrative embodiment of the function of search-based video system 10 of FIG. 1. Method 200 includes step 201, of receiving a search term via remote user input device, such as remote control 20; step 203, of searching audio/video files accessible on a network 14 for audio/video files relevant to the search term; step 205, of providing user-selectable search results indicating one or more of the audio/video files that are relevant to the search term; and step 207, of responding to a user selection by playing the audio/video file selected by the user.

The user-selectable search results may be provided as representative indicators, such as snippets of text and thumbnail images, of the audio/video files that are relevant to the search term, and may include a link to a network source for the audio/video file. The search results may be provided on monitor 16, which has both a network connection, and a television input, such as a broadcast television receiver or a cable television input. The video system 10 may thereby be configured to display content on the monitor 16 from either a network source or a television source, in response to a user making a selection with the remote control 20 of content from either a network source or a television source.

Video system 10 may be implemented in any of a wide variety of different ways. In the illustrative example of FIG. 1, video system 10 may include a television set with a broadcast receiver and cable box, as well as a connection to a desktop computer with an Internet connection, and a remote control interface connected to the computer rather than to the television. In another illustrative example, video system 10 may include a television set with an integrated computer, Internet access, and streaming video playback capability. In yet another illustrative example, video system 10 may include a set-top box with an integrated computing device, Internet connection, cable tuner, and remote control signal receiver, with the set-top box communicatively connected to the television. The capabilities and methods for video system 10 may be encoded on a medium accessible to computing device 12 in a wide variety of forms, such as a C# application, a media center plug-in, or an Ajax application, for example. A variety of additional implementations are also contemplated, and are not limited to those illustrative examples specifically discussed herein.

Video system 10 is then able to play video or audio content from either a network source or a television source. Network sources may include an audio file, a video file, an RSS feed, or a podcast, accessible from the Internet, or another network, such as a local area network, a wide area network, or a metropolitan area network, for example. While the specific example of the Internet as a network source is used often in this description, those skilled in the art will recognize that various embodiments are contemplated to be applied equally to any other type of network. Non-network sources may include a broadcast television signal, a cable television signal, an on-demand cable video signal, a local video medium such as a DVD or videocassette, a satellite video signal, a broadcast radio signal, a cable radio signal, a local audio medium such as a CD or audiocassette, or a satellite radio signal, for example. Additional network sources and non-network sources may also be used in various embodiments.

Video system 10 thereby allows a user to enjoy Internet-based video in a television-like setting, which may typically involve display on a large, television-like screen set across a room from the use, with a default frame size for the video playback set to the full size of the television screen, in this illustrative embodiment. This provides many advantages, such as allowing many users easily to watch the video together; allowing a user to watch the video content from a casual setting typical of television viewing, such as from the comfort of a couch or easy chair typical of a television viewing setting, rather than in the work-type setting typical of computer use, such as sitting in an office chair at a desk; allowing a user to watch Internet-based video with premium video and audio equipment invested in the user's television-viewing setting, without the user having to invest in a second set of premium video and audio equipment; and watching Internet-based video on what for many users is a much larger screen on their television set relative to the screen on their computer monitor. This may also include either high definition television screens, or television screens adapted to older formats such as NTSC, SECAM, or PAL.

Video system 10 also allows a user to enjoy Internet-based video in a setting typical of television viewing in that it is requires user input only through a simple remote control in this illustrative embodiment, as is typical of user input to a television, as opposed to user input modes typical of computer use, such as a keyboard and mouse. The remote control 20 of video system 10 may be similar to a typical television remote control, having a variety of single-action buttons and an alphanumeric keypad typically used for entering channel numbers. Video system 10 allows such a simple remote control to provide all the input means the user needs to search for, browse, and play Internet-based video in this illustrative embodiment, as is further described below.

On-demand audio files from network sources, such as audio-only podcasts, for example, may be played in addition to video files. Audio/video files are sometimes mentioned in this description as a general-purpose term to indicate any type of files, which may include video files as well as audio-only files, graphics animation files, and other types of media files. While many references are made in this description to video search or video files, as opposed to audio/video search or audio/video files, those skilled in the art will appreciate that this is for the sake of readability only and that different embodiments may treat any other type of file in the same way as the video file being referred to. For the case of audio files, the screen would still provide a user interface including a user-selectable search field; search results, including indicators such as transcript clips, thumbnail images of an icon related to the audio file source or some other image related to the audio file, links to the audio file sources, or other search result indicators. During playback of an audio file, the screen may be allowed to go blank, to run a screensaver, to display text such as transcript portions from the audio file, to display images related to the audio file provided as metadata with the audio file, or to display an ambient animation or visualization that incorporates the signal of the audio file, for example.

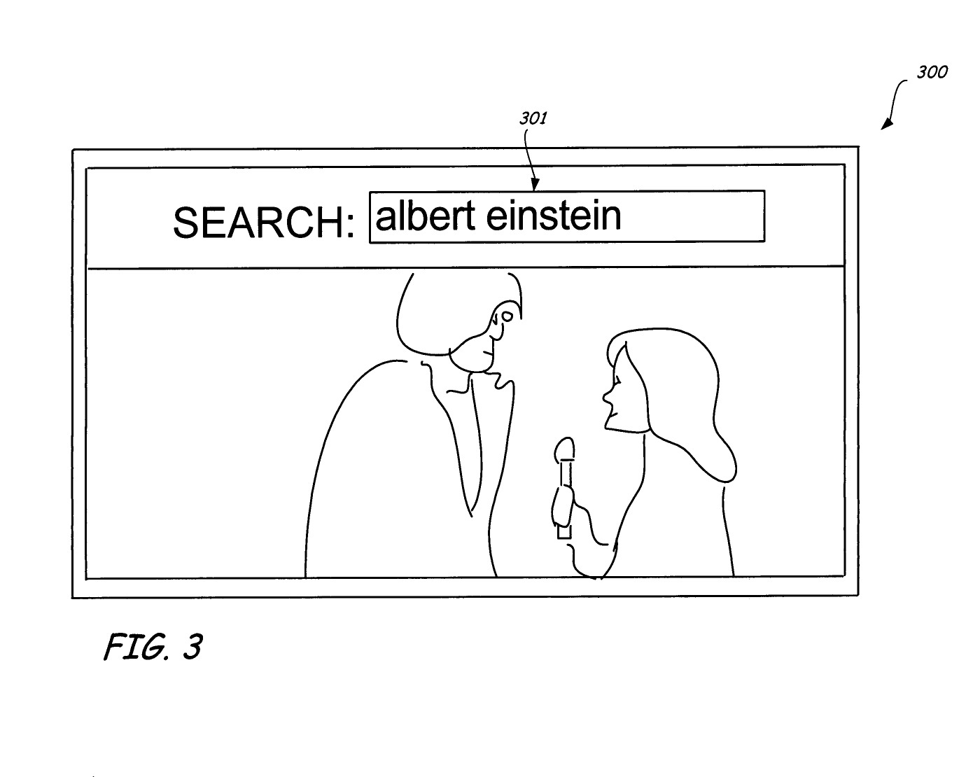

Video system 10 according to one illustrative embodiment may be further illustrated with depictions of screenshots of monitor 16 during use. These appear in FIGS. 3-9, according to one illustrative embodiment; these figures and their accompanying descriptions are understood to illustrate only an example from among many additional embodiments. FIG. 3 depicts monitor 16 displaying a cable television program, with a search field 301 superimposed over the television program at the top of the screen. A user who is watching a television program can open such a search field using a single-action input, such as pressing a single “search” button on the remote control 20, while watching any content on monitor 16.

Once the search field is opened, the user may use remote control 20 to enter a search term. The search field 301 displays the search term as it is received from remote control 20. The search term may include any words, letters, numbers, or other characters entered by the user. Entering the search term may be done using methods not requiring a unique key for every possible character to enter, such as with a fill keyboard. Instead, for example, the search term entry may use methods to allow the user to press sequences of keys on an alphanumeric keypad on the remote control 20 and translate those sequences into letters and words. For example, one illustrative embodiment uses a predictive text input method for entering the search term, such as are sometimes used for SMS text messaging and handheld devices. In an illustrative example, a predictive text input uses a numeric keypad with three or four letters associated with each of the numbers; a user presses the number keys in the order of the letters of a word the user intends to enter; and a computing device compares the numeric sequence against a dictionary or corpus to find words that can be made with letters in the sequence corresponding to the sequence of numbers.

Using an abbreviated text input mode like predictive text input allows a user to make text entries into the search field using only a remote control not very different from a standard television remote control, rather than requiring a user to enter text into a search field using a keyboard, as is typical in a computer usage setting. Enabling search using only a remote control, which may easily be held in one hand or even operated easily with one thumb, rather than requiring a keyboard, which typically needs to sit on a desk or some other surface in front of a user, or else is implemented on a handheld device with inconveniently small keys, adds to the television-like setting of the video search methods of video system 10, and its advantages as a setting for viewing video files.

The predictive text input method may use a regular print corpus of text, such as the combined content of a popular newspaper over a significant length of time, to measure rates of usage of different words and give greater weight to more commonly used words in predicting the text the user intends to enter with a given sequence of numeric inputs. Instead of or in addition to a regular print corpus, the predictive text input may also use a corpus of transcripts and metadata from video/audio files, from sources such as those similar to what a user might search, in ranking predictive text for the search term. Additionally, the predictive text input may refer to transcripts and metadata of recently released audio/video content in ranking predictive text for the search term. This may involve an ongoing process of adding new transcripts and metadata to a corpus, and reordering search weights of different words as some fall into disuse and others surge in popularity. It may also include adding entirely new words to the corpus that were little or never used in the pre-existing corpus, but that are newly invented or newly enter popular usage, such as has occurred recently with “podcast”, “misunderestimated”, and “truthiness”. Adding new words from recent sources as they become available therefore provides advantages in keeping both the weighting and the content of the corpus current.

In one illustrative embodiment, a search may also be constrained by entering a category of content in which to limit the search. For example, another button on remote control 20 may open a search category selection menu, in which a set of selectable categories is provided, such that a selected category is used as a constraint for searching the transcripts of the audio/video files. For example, the search category menu may include categories such as “news”, “world news”, “national news”, “politics”, “science”, “technology”, “health”, “sports”, “comedy”, “entertainment”, “cartoons”, “children's programming”, etc. A search term may be entered in the search field 301 in the same way in tandem with a search category being selected. The selection of a search category advantageously limits a search to a desired category of content. For example, a search for a widely known political figure entered without a search category may return a lot of results from comedy-oriented content, whereas a user interested in factual reporting on the figure can receive search results more relevant to her interests by selecting a “news” search category along with entering the figure's name as the search term.

After entering a search term, the user may execute a search based on that search term by entering another single-action input, which may be, for example, pressing an “enter” button. The function of the “enter” button in this illustrative embodiment is versatile depending on the current state of video system 10. When the search is executed, computing device 12 performs a search of the Internet or of other network resources for video files that correspond to the search terms. It may do so, for example, by searching for transcripts of video files, and comparing the transcripts to the search terms. It may employ any type of search methods useful for searching the Internet, such as weighting search results toward sources with a greater number of links linking to them; toward files with several occurrences of the search terms; toward files that are relatively more recent than others; and toward files in which the search term is vocally emphasized by those speaking it, for example, among many other potential search ranking criteria.

The search term may be compared with video files in a number of ways. One way is to use text, such as transcripts of the video file, that are associated with the video file as metadata by the provider of the video file. Another way is to derive transcripts of the video or audio file through automatic speech recognition (ASR) of the audio content of the video or audio files. The ASR may be performed on the media files by computing device 12, or by an intermediary ASR service provider. It may be done on an ongoing basis on recently released video files, with the transcripts then saved with an index to the associated video files. It may also be done on newly accessible video files as they are first made accessible. Any of a wide variety of ASR methods may be used for this purpose, to support video system 10. Both metadata text and ASR-derived text from new content may also be used together with a prior print-derived or transcript-derived corpus to modify the predictive text input. Because many video files are provided without metadata transcripts, the ASR-produced transcripts may help catch a lot of relevant search results that are not found relevant by searching metadata alone, where words from the search term appear in the ASR-produced transcript but not in the metadata, as is often the case.

As those skilled in the art will appreciate, a great variety of automatic speech recognition systems and other alternatives to indexing transcripts are available, and will become available, that may be used with different embodiments described herein. As an illustrative example, one automatic speech recognition system that can be used with an embodiment of a video search system uses generalized forms of transcripts called lattices. Lattices may convey several alternative interpretations of a spoken word sample, when alternative recognition candidates are found to have significant likelihood of correct speech recognition. With the ASR system producing a lattice representation of a spoken word sample, more sophisticated and flexible tools may then be used to interpret the ASR results, such as natural language processing tools that can rule out alternative recognition candidates from the ASR that don't make sense grammatically. The combination of ASR alternative candidate lattices and NLP tools thereby may provide more accurate transcript generation from a video file than ASR alone.

As another illustrative example, lattice transcript representations can be used as the bases of search comparisons. Different alternative recognition candidates in a lattice may be ranked as top-level, second-level, etc., and may be given specific numbers indicating their accuracy confidence. For example, one word in a video file may be assigned three potential transcript representations, with assigned confidence levels of 85%, 12%, and 3%, respectively. During a search, a greater rank may be assigned to a search result with a recognition candidate having an 85% accuracy confidence, that matches a word in the search term. Search results with recognition candidates having lower confidence levels that match words in the search term may also be included in the search results, with relatively lower rankings, so they may appear after the first few pages of search results. However, they may correspond to the user's intended search, whereas they would not have been included in the search results if a single-output ASR system is used rather than a lattice-representation ASR system.

As another illustrative example, different ASR systems are not constrained to generate simply orthographic transcripts, but may instead generate transcripts or lattices representing smaller units of language or including additional data in the representation, such as by generating representations of parts of words and/or of pronunciations. This allows speech indexing without a fixed vocabulary, in this illustrative embodiment.

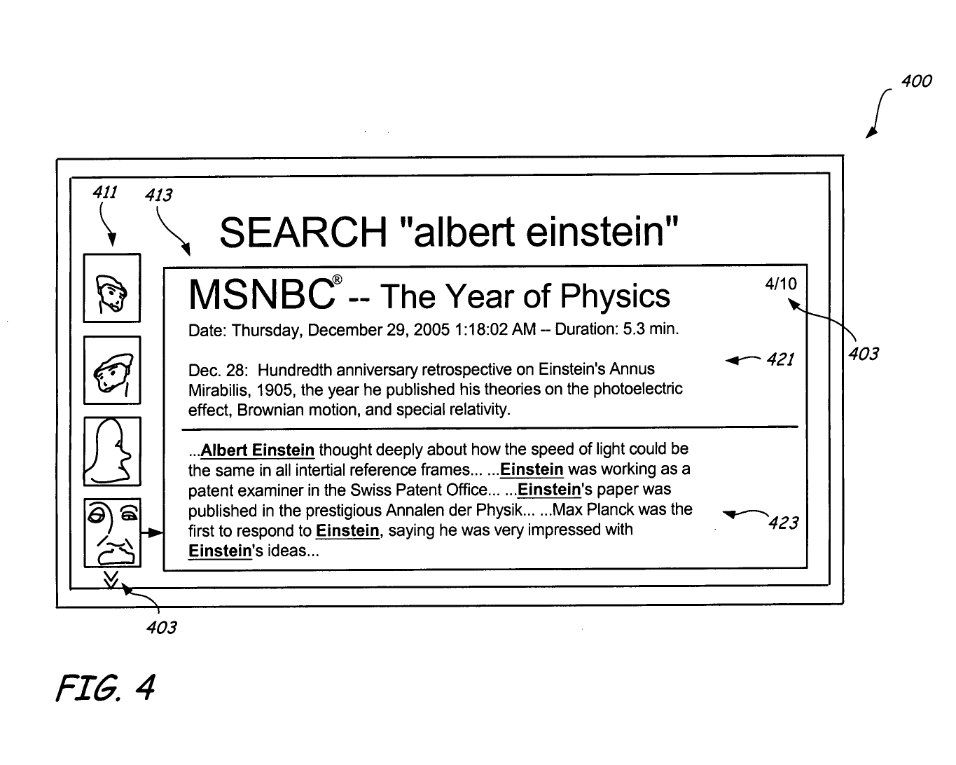

FIG. 4 depicts a screenshot 400 of the monitor displaying a search results page. The highest weighted results, based on any of a variety of weighting methods intended to rank the video files in order from those most relevant to the search term, may be displayed first. The search results page 400 may depict any number of search results per page. The screen may also depict an arrow 403 pointing down at the bottom of the screen indicating that a user may scroll down to view additional results; an indication of page numbers indicating that the user can select an additional page of search results; or an indicator 405 of the number of the search result being viewed compared to the number of search results on the current page, for example.

Each of the search results may include various indicators of the video files found by the search. The indicators may include thumbnail images 411 and snippets of text 413. The thumbnail images may include a standard icon provided by the source of the video file, a screenshot taken from the video file, or a sequence of images that plays on the search results screen, and may loop through a short sequence. A screenshot thumbnail may be provided by the source of the video file, or may be created automatically by computing device 12, by automatically selecting image portions from the video files that are centered on a person, for example. Selecting a still image centered on a person from a video file may be done, for example, by applying an algorithm that looks for the general shape of a person's head and upper body, that remains onscreen for a significant duration in time, and that remains relatively still relative to the screen but also exhibits some degree of motion consistent with talking and changing facial expressions. The algorithm may isolate a still image from a sequence fulfilling those conditions; it may also crop the image so that the person's head and upper body dominate the thumbnail image, so that the image of the person's face is not too small. The algorithm may also ensure that a thumbnail image for a video file is not created based on an advertisement appearing as a segment within the video file.

The snippets of text provided on the search results page may include metadata 421 describing the content of the video file provided by the source of the video file, and may also include samples of the transcript 423 for the video file, particularly transcript samples that include the word or words from the search term, which may be emphasized by being highlighted, underlined, or portrayed in bold print, for example. The metadata may include the title of the video file, the date, the duration, and a short description. The metadata may also include a transcript, in some cases, in which case portions of the metadata transcript including words from the search term may be provided in place of transcript portions derived by ASR. The metadata may also contain a trademark or other source identifier of the source of the content in a video file. This is depicted in FIG. 4 and later figures with the source identifier MSNBC®, a registered trademark belonging to MSNBC Cable L.L.C., a joint venture of Microsoft Corporation, a corporation of the state of Washington, and NBC Universal, Inc., a corporation of the state of Delaware.

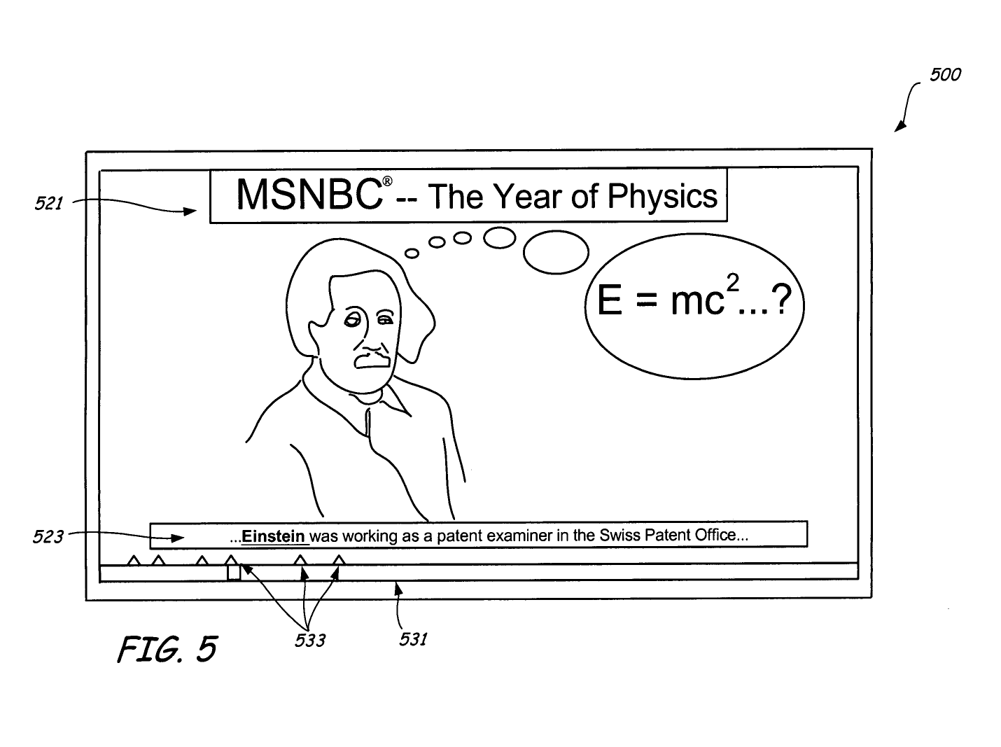

Using the remote control 20, a user may scroll up and down or to additional pages of search results. The user may also select one of the search results to play. In an illustrative embodiment, the user is not limited to having the selected search result video file play from the beginning of the file, but may also scroll through the instances of the search term words in the text snippets of a given search result, and press a play button with one of the search terms selected. This begins playback of the video file close to where the search term is spoken or sung in the video or audio file, typically beginning a small span of time prior to the utterance of the search term. A user is also enabled to skip directly between these different instances of the words from the search term being spoken in the video file, during playback, as is explained below with reference to FIG. 5.

FIG. 5 depicts a screenshot 500 of the monitor playing the selected video file. As shown, a brief sample of metadata 521 may be displayed onscreen as well, at least when playback first begins, such as a source identifier, a title, or a brief description of the video file or the particular segment thereof. A close caption transcript 523 may also be displayed, either one provided as metadata or derived by ASR, and may depict occurrences of a search term word in bold or underline, for example. A timeline 531 of the video file may also be depicted as shown, as is commonly done for playback of video files. In addition, the timeline may include markers 533 showing where in the progress of the video file each detected occurrence of one of the words from the search term appears in the video file. A user may select to skip back and forth through these markers with a single-action back button and forward button on remote control 20. Skipping from one marker to another one may restart playback a short time prior to the next occurrence of the search term being spoken in the video file. This may be of significant help for the user in finding desired content within the video file. Color coding may also be used to convey information, such as by modifying the color of the timeline to indicate that a search term word is approaching. For example, in one embodiment, the timeline is blue by default, but then shades through white, yellow, and orange to red, as if “getting warmer”, to indicate the approach and then occurrence of a word from the search term, with the color then fading back to blue.

The user may also skip from one sentence boundary to another during playback. Sentence boundaries may be determined simply by detecting relatively extended pauses during speech. They may also be determined with more sophistication by applying ASR and then various natural language processing (NLP) methods to the audio component of the file. Skipping between sentence boundaries may help a user navigate over relatively shorter spans of time in the video file. The user may also select a mode where the transcript is not shown most of the time, but the transcript appears on occasions when one of the search term words is spoken. Any of the metadata display, the timeline, or the transcript may also be turned on or off by the user; they may also appear for a brief period of time when playback of the video file first begins, then disappear. Audio files with no video component may nevertheless also be accompanied during playback by any of the metadata display, the timeline, the timeline markers indicating occurrences of the search term, or the transcript provided on the monitor during playback of the audio file, with navigation between the timeline markers.

Playback of a video file may also be paused anytime while the user performs another search, or flips to another channel or content source, such as a television channel or a DVD playback. In one embodiment, playback of the video file is automatically paused when another input source is selected. Playback of a DVD or of a television station may also be automatically paused when a search is executed or an Internet video file is accessed, with any transitory signal source such as cable or broadcast television being recorded from the point of pause to enable later playback.

The search results screen may also provide an additional option besides full playback of a selected video or audio file: an option to play a brief video preview of a selected video file. The computing device 12 may, for example, isolate a set of brief video clips from the video file. The clips may be centered on utterances of the search term words, in one embodiment. In another embodiment, the video clips may be selected based on more sophisticated use of ASR and NLP techniques for identifying clips that are spoken in an emphatic manner, that feature rarely used words or combinations of words, that combine the previous features with occurrences of the search term, or that use other methods for identifying segments potentially of particular importance. The previews may be created and stored when the video files are first found, transcribed, and indexed, in an illustrative example.

A transcript caption, either from metadata or ASR, may be provided along with the video clips in the video preview. A user may also be provided the option to start the selected video file at the beginning, or to start playback from one of the clips shown in the preview. Once again, these methods also ensure that content is not selected from an advertisement section of the video files.

For example, in one embodiment, user-selectable video previews of three clips of five seconds each have been tested, which were found to provide a significant amount of information about the nature of the video file and its relevance to the search term, without taking much time, making it easy for a user to quickly play through several video previews before selecting a video file for playback. In one embodiment, an advertisement may be inserted before playback, after a user has viewed the video preview and selects playback of the video file. Other embodiments may do without advertisements.

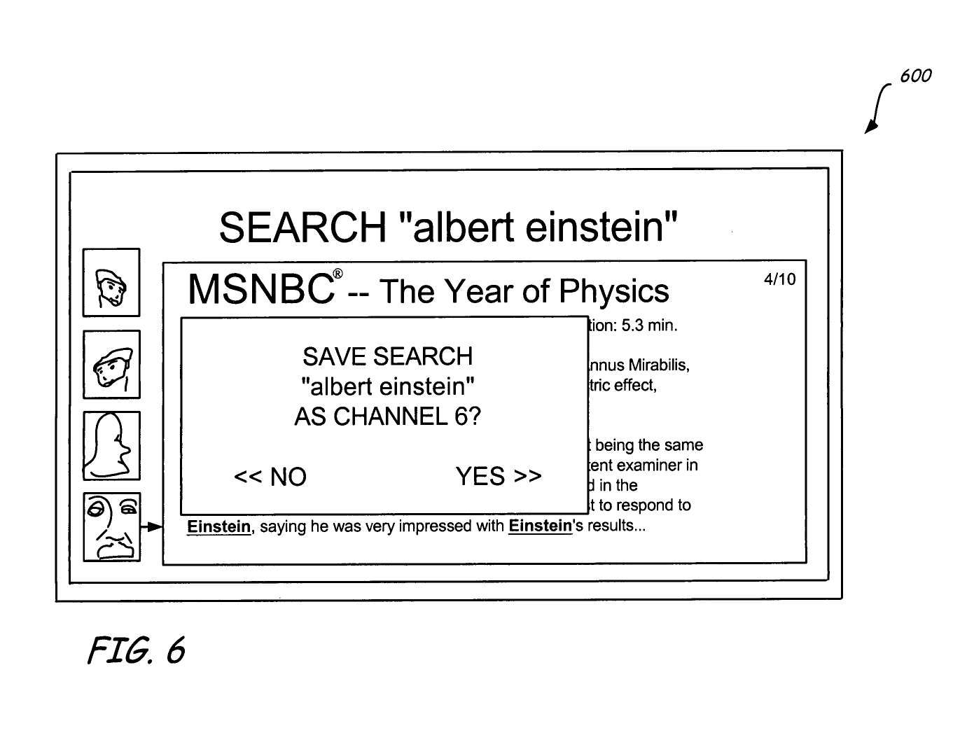

FIG. 6 depicts another feature in screenshot 600: the option to save a search as a channel. Once again, this option may be engaged with a single-action user input, such as by pressing a single “save search” button on remote control 20. When engaged, the saved search is associated with a channel. As depicted in screenshot 600, video system 10 is asking for confirmation to save the search as a channel, with the channel number 6. This may be confirmed by pressing the right-side button on a set of directional buttons, for example. In another embodiment, the step of confirming the save of the search as a channel may be skipped, and the single-action input of pressing a “save search” button may automatically save the search as the next available channel number, and provide a confirmation message such as “Search saved as channel 6”.

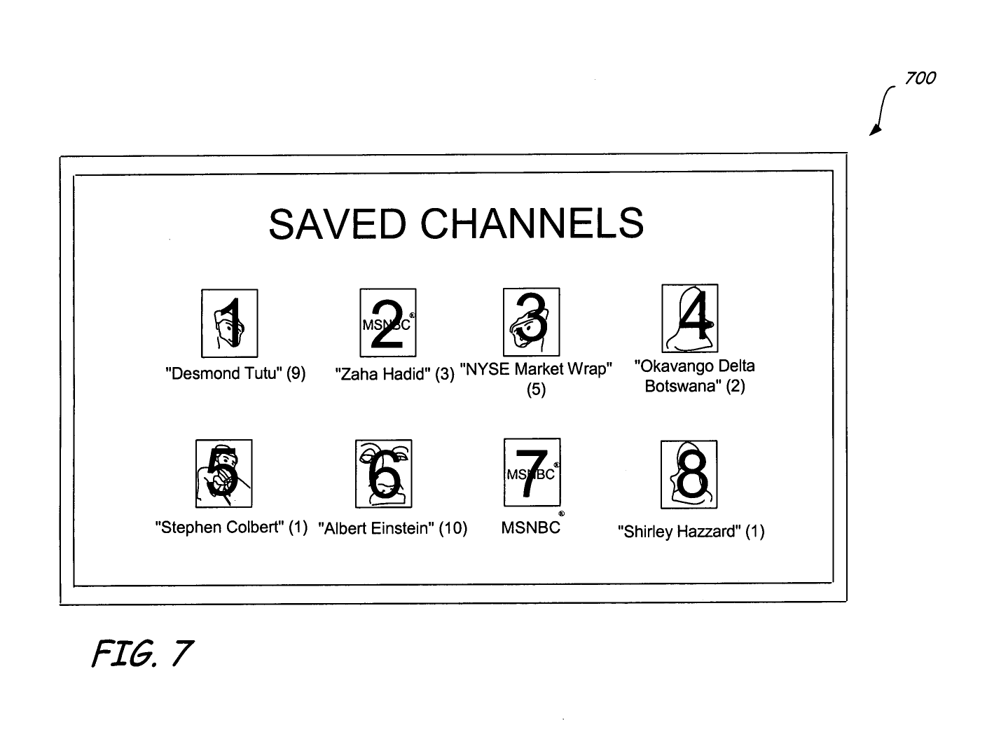

Once a search is saved as a channel, the search for audio/video files relevant to the search term is automatically, periodically repeated, providing potentially new search results that are added to the channel, or new weightings of different search results in the order in which they will be presented, as time goes on, new video files are made accessible, and other factors relied on by the search algorithm change. These periodically refreshed search results are then ready to be provided as soon as the user selects the channel number associated with that search again. A saved search channel may be accessed with an abbreviated-action input, such as a single-action, double-action, triple-action, or quadruple-action input, such as entering a single number on a number keypad, entering a two-digit number for channels of zero to 99 (with a zero first for single digit numbers in this embodiment), or entering either a one, two, or three digit number and then hitting an “enter” button, for example. Alternatively, the user may be enabled to call up a saved search menu page or set of pages, as depicted in screenshot 700 of FIG. 7. Saved channels may also be stored in a common number scheme with cable or broadcast television channels, in an illustrative embodiment. For instance, video system 10 may assign saved search channels to numbers not already assigned to television stations or previously assigned saved search channels. A user may then select a channel change option enabling the user to switch back and forth between saved search channels and television channels with nothing more than a simple single-action or double-action input, such as by pressing a simple one or two digit number.

Screenshot 700 of FIG. 7 shows a variety of saved channels and their associated channel numbers, accompanied by a text caption of the search term for each search channel, a thumbnail image of one of the videos saved in that search channel, and a channel number. Each channel indicator may also include a numeral indicating the number of new, unviewed video files in that channel, as explained further below. The thumbnail image, once again, may be either a logo or icon, such as a source identifier by a source of one of the videos saved in the search channel, or a still image captured from one of the videos saved in that channel. In one embodiment, the still image for each search channel is kept the same over time, even if the video from which it was originally taken drops in the ranking of relevance for that search channel, to be easier for a user to remember and associate the image with the search channel. A user may select a channel by pressing the button or buttons for that channel on the remote control 20, or by using directional keys to navigate among the channels on the monitor before hitting an “enter” or “select” button to play a channel navigated to.

Whenever the user selects a channel, video system 10 may provide a search results screen, such as that depicted in screenshot 300 of FIG. 3. In another option, selecting a channel may simply begin playing the highest-ranked video in that channel's search results by default, and proceed after playback of that first video file to play through the subsequent video files in the ranking for the search results, while the user has the option to go instead to the search results page. This automatic, user-selectable continuous-play option provides a viewing experience similar to that of watching a traditional channel on television; rather than experience periodic interruptions to navigate or perform new searches after the end of each video file, the user can watch one video file after another, progressing through the order of those stored in the channel. This may also include storage of indicators of which video files the user has already viewed or has already skipped through, so that when the channel is next turned on, video system 10 accesses a ranking that omits previously viewed video files and prioritizes new releases.

When video system 10 discovers a new file found to be relevant to a particular channel and adds it to the channel, it may also provide an indication to the user, for example by providing a transient pop-up notification box on monitor 16 or the monitor or screen of another computing device of the user's. The transient new file indicator pop-up may be turned off as selected by a user, and may turn off automatically under certain circumstances, such as when a DVD is being played on monitor 16. Video system 10 may also store an indication of the total number of new, unviewed video files, listed next to the identifying information of each channel, for the user to see when beginning a new usage session with video system 10. The user also has the option to skip forward or backward from one video file to the next or to the previous one in the ranked order, as well as back and forth between occurrences of the search term words being spoken within each video.

A search results screen may also be generalized to be combined with a television channel guide screen, that displays indicators of both saved search channels and cable or broadcast television channels together in one channel guide screen. Saved searches may also be deleted and their channel numbers be freed up for reassignment if selected by a user. Channels may also be assigned not only to saved searches, but also to other forms of video and audio delivery such as podcasts, which may also be accessed and managed in common with television channels and saved search channels.

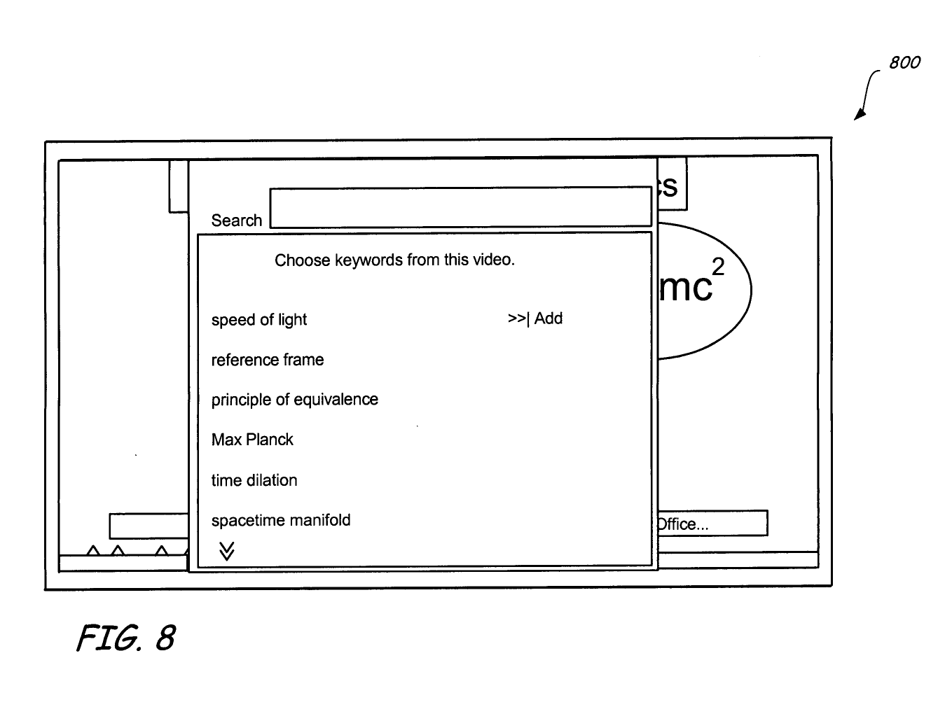

FIG. 8 depicts another feature, in screenshot 800: a related results search. In one illustrative embodiment, when a related results search is selected by a user, keywords are extracted from a previously selected audio/video file and provided to the user, as depicted in screenshot 700. These are automatically extracted from a video file currently or previously viewed by the user. Video system 10 may select as keywords words that are repeated several times in the previously selected video file, words that appear in proximity a number of times to the original search term, words that are vocally emphasized by the speakers in the previously selected video file, unusual words or phrases, or that stand out due to other criteria. Keyword selection may also be based on more sophisticated natural language processing techniques. These may include, for example, latent semantic analysis, or tokenizing or chunking words into lexical items, as a couple illustrative examples. The surface forms of words may be reduced to their root word, and words and phrases may be associated with their more general concepts, enabling much greater effectiveness at finding lexical items that share similar meaning. The collection of concepts or lexical items in a video file may then be used to create a representation such as a vector of the entire file that may be compared with other files, by using a vector-space model, for example. This may result, for example, in a video file with many occurrences of the terms “share price” and “investment” being ranked as very similar to a video file with many occurrences of a video file with many occurrences of the terms “proxy statement” and “public offering”, even if few words appear literally the same in both video files. Any variety of natural language processing methods may be used in deriving such less obvious semantic similarities.

However, documents that are too similar may be discounted from search rankings, to avoid rebroadcasts of the same file, long clips of the same material excerpted in another file, or a reread of the same news stories by different anchors, for example. As another example, the title of the file in the metadata may normally be given great weight in search rankings, but this weight should be selectively applied to comparison with internal content of other files, rather than the metadata titles of other files, to avoid search results being dominated by other episodes of the same program, which may share relatively little of the same content as that intended to be searched. Additional limiting factors, such as manually entered supplemental keywords in the search field, may also be used to direct a search toward a specific category of desired content.

These keywords are then presented in a keyword menu, which may be called up by a single-action input, such as by pressing a single “related results search” button, in an illustrative example. A user may then select one or more of these keywords from the menu, such as by navigating with directional keys, and pressing a “select” button on the remote control for the keyword or keywords that interest the user, causing the selected keyword or keywords to appear in the search field depicted at the top of the screenshot 701, then pressing the “search” button. Alternately, the user may simply navigate to a single search term and hit the “search” button directly, skipping the chance to select more than one keyword to include in the new search term. Viewing system 10 may then perform a new search, similarly to the previous search, but on the automatically extracted keyword or keywords that the user includes in the new search term.

Another illustrative option provides an automatic related results search. When a user selects a button for this option, computing device 12 selects a keyword or keywords from the previously selected video file as before, except that it also selects the keyword or keywords that it ranks as the most highly relevant, and automatically performs a search on that keyword or those keywords. Whether it searches a single keyword or a set of keywords may depend on how close the gap in evaluated relevance is between the most highly relevant keyword and the next most relevant keywords, with an adjustable tolerance for how narrow the gap in relevance is to qualify the secondary keywords in the search term. It may also depend on feedback in the form of a relative scarcity of results for too narrow a search term prompting a repeat search with fewer keywords or the single most relevant keyword.

The automatic related results search may take the user straight to a search results screen similar to that of FIG. 4, with search results based on the automatically selected keyword or keywords, displayed as indicators of video files found to be relevant to the new search. The user may also have the option to select a more fully automatic search, which skips the search results screen also, automatically selects the highest ranked video file in the search results of the automatically selected keyword, and thereby goes straight from the previously selected video file to playback of a newly searched video file.

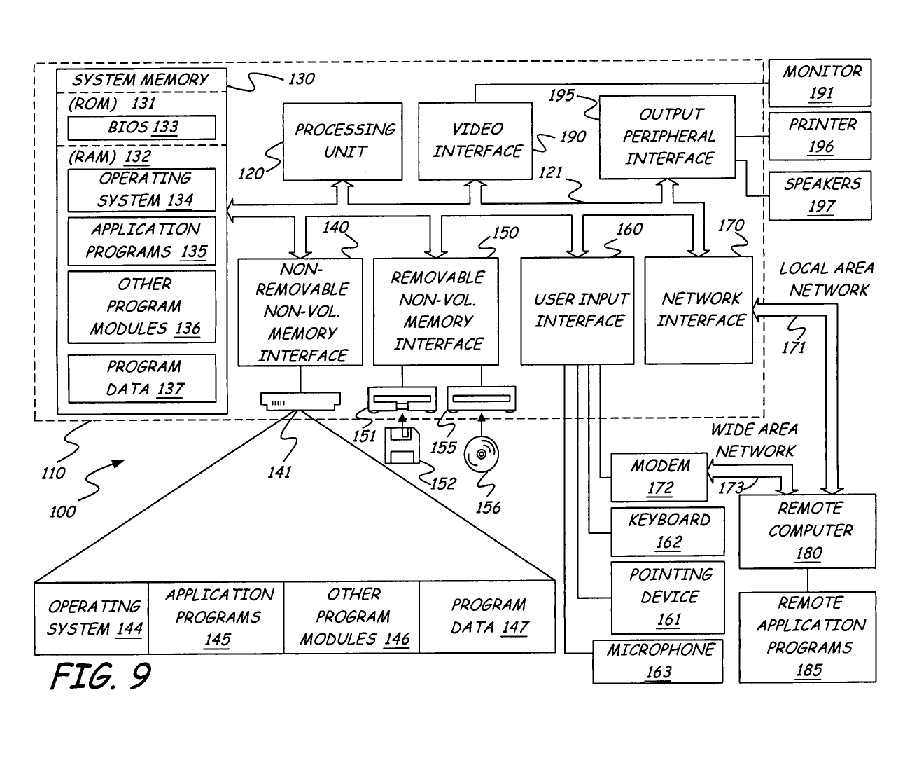

FIG. 9 depicts a computing environment 100, to provide a more detailed example of an illustrative environment of computing device 12, network 14, and their associated resources. Different embodiments of search-based video can be implemented in a variety of ways. The following descriptions are of illustrative embodiments, and constitute examples of features in those illustrative embodiments, though other embodiments are not limited to the particular illustrative features described. As with all the previous illustrative embodiments described above, other embodiments are not limited to the particular illustrative features described.

A computer-readable medium may include computer-executable instructions that may be executable at least in part on a computing device, such as computing device 12 of FIG. 1 or computer 110 of FIG. 9, and that configure a computing device to run applications, perform methods, and provide systems associated with different embodiments, one of which may be the illustrative example depicted in FIG. 9.

FIG. 9 depicts a block diagram of a general computing environment 100, comprising a computer 110 and various media such as system memory 130, nonvolatile magnetic disk 152, nonvolatile optical disk 156, and a medium of remote computer 180 hosting remote application programs 185, the various media being readable by the computer and comprising executable instructions that are executable by the computer, according to an illustrative embodiment. FIG. 9 illustrates an example of a suitable computing system environment 100 on which various embodiments may be implemented. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Various embodiments may be implemented as instructions that are executable by a computing device, which can be embodied on any form of computer readable media discussed below. Various additional embodiments may be implemented as data structures or databases that may be accessed by various computing devices, and that may influence the function of such computing devices. Some embodiments are designed to be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 9 illustrates operating system 134, application programs 135, other program modules 136, and program data 137.

The computer 110 may also include other removable/non-removable volatile/nonvolatile computer storage media. By way of example only, FIG. 9 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 9, provide storage of computer readable instructions, data structures, program modules and other data for the computer 110. In FIG. 9, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may be operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 9 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 9 illustrates remote application programs 185 as residing on remote computer 180. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implementable at least in part by a computing machine, comprising:
receiving a search term via a remote user input device;
searching audio/video files accessible on a network for audio/video files relevant to the search term;
providing user-selectable search results indicating one or more of the audio/video files that are relevant to the search term; and
playing a selected one of the audio/video files on a monitor configured to display content from either a network source or a television source.

2. The method of claim 1, wherein the remote user input device uses a predictive text input method for entering the search term.

3. The method of claim 2, wherein the predictive text input method refers to at least one of transcripts or metadata of recently released audio/video content in ranking predictive text for the search term.

4. The method of claim 1, further comprising providing a set of selectable categories, wherein a selected category is used as a constraint for searching the transcripts of the audio/video files.

5. The method of claim 1, wherein searching audio/video files comprises searching metadata comprising transcripts associated with the audio/video files.

6. The method of claim 1, wherein searching audio/video files comprises searching transcripts generated by automatic speech recognition based on audio content of the audio/video files.

7. The method of claim 1, further comprising responding to a single-action save input by saving the search term, associating it with a channel, periodically repeating a search for audio/video files relevant to the search term, and adding new search results to the channel.

8. The method of claim 7, further comprising a user-selectable continuous-play option comprising playing one search result after another from the search results associated with a selected channel number.

9. The method of claim 7, further comprising a user-selectable channel change option enabling a user to change from one channel to another, from among channels comprising both saved search channels and television channels, with either a single-action or double-action channel change input.

10. The method of claim 7, further providing a user-selectable channel guide screen displaying indicators of a plurality of the saved search channels.

11. The method of claim 1, wherein the search results comprise images and portions of transcripts of the audio/video files relevant to the search term, wherein the images for the search results are created by automatically selecting image portions that are centered on a person from the audio/video files relevant to the search term.

12. The method of claim 1, further comprising enabling a user-selectable preview option wherein one or more audio/video clips comprising spoken words corresponding to words in the search term are provided, with an option for a user to select to watch an audio/video file that includes the one or more audio/video clips.

13. The method of claim 12, further comprising responding to a user selecting to watch the audio/video file by providing an advertisement between the one or more audio/video clips and the audio/video file.

14. The method of claim 1, further comprising providing a timeline in a portion of the screen while an audio/video file is being played, with markers indicating occurrences of spoken words corresponding to the search term, wherein a user-selectable single-action input is enabled to jump from one of the markers to another one of the markers.

15. The method of claim 1, further comprising enabling a user-selectable related results search, wherein keywords extracted from a previously selected audio/video file are provided, and a user is enabled to select one or more of the keywords as search terms for a new search for audio/video files related to the previously selected audio/video file.

16. The method of claim 1, further comprising enabling a user-selectable automatic related results search, wherein indicators of one or more audio/video files related to a previously selected audio/video file are provided, and a user is enabled to select one of the indicators of the related audio/video files.

17. The method of claim 16, wherein the related results search uses semantic analysis of transcripts of the previously selected audio/video file and the audio/video files being searched, to select the related audio/video files to provide as the related results.

18. A medium comprising instructions executable at least in part on a computing device, wherein the instructions configure the device to:
receive search terms from a remote user input device;
search a network for transcripts associated with audio/video files that correspond to the search terms;
display representative indicators of one or more of the audio/video files that correspond to the search terms on a monitor configured to display content from either a network source or a television source in response to a selection received from the remote user input device;
receive a selection of one of the representative indicators from the remote user input device, indicating a selected audio/video file; and
play the selected audio/video file on the monitor.

19. The medium of claim 18, wherein the instructions further configure the device to respond to a single-action search field input from the remote user input device by opening a search field in a portion of the monitor, while the device is displaying content on the monitor from either a network or a non-network source, wherein the search field displays the search terms subsequently received from the remote user input device, prior to searching the network for transcripts associated with audio/video files that correspond to the search terms.

20. A medium comprising instructions executable at least in part on a computing device, wherein the instructions configure a system comprising the computing device to:
receive a user-input search term from a remote user input device;
search a network for audio/video files that correspond to the user-input search term;
provide links on a television monitor corresponding to one or more of the audio/video files that correspond to the user-input search term;
receive an indication from the remote user input device of a user-selected link from among the links provided on the television monitor; and
play the audio/video file corresponding to the user-selected link on the television monitor.
